(19) United States
(12) Patent Application Publication
(10) Pub. No.: US 2016/0221386 A1
(43) Pub. Date: Aug. 4, 2016

(54) WHEEL

(71) Applicant: Silverstone, Inc., Omaha, NE (US)

(72) Inventor: Tom Whyte, Omaha, NE (US)

(21) Appl. No.: 14/608,912

(22) Filed: Jan. 29, 2015

(51) Int. Cl. B60B 3/08

(52) U.S. Cl. CPC B60B 3/087; B60B 2320/14; B60B 2900/325; B60B 2900/721

(57) ABSTRACT

A multi-piece wheel assembly is provided to allow use for extreme duty agricultural equipment of a low profile side wall tire that has less internal volume and thus requires less foam fill and cost to flat-proof the tire. In various non-limiting aspects, the wheel assembly is a multi-piece wheel assembly, preferably a two-piece wheel, allowing the mounting of a low profile tire, in particular a low profile extreme duty agricultural implement tire, to the wheel assembly.

### TECHNICAL FIELD

This disclosure concerns wheels for rough terrain vehicles. More particularly, this disclosure concerns a multi-piece wheel rim for extreme duty agricultural equipment, such as heavy duty rotary cutters.

### BACKGROUND

Rotary cutters are an example of extreme duty agricultural equipment. They are typically PTO-driven and connected to a tractor via a drawbar. They are normally used to mow medians, ditches, and right-of-ways along public roads as well as waterways in agricultural fields. These mowers operate in a harsh environment. Trash and debris frequently puncture and/or destroy ordinary pneumatic tires.

To address this issue, many manufacturers utilize used aircraft tires. Aircraft tires are designed for high load capacity and small size, so they contain a high number of plies (for example, 16-20 plies). This high ply count also works to offer a large degree of puncture resistance. When these tires are installed on rotary cutters, many customers choose to additionally fill the tires with foam to create non-pneumatic tires that are free from flats.

The aircraft tire, however, has several drawbacks, including:
a) Relatively high cost;
b) the additional cost in foam-filling to be flat-free; and
c) a limited supply of used aircraft tires having a growing demand and a shrinking supply.

Conventional tires in this size also have significant drawbacks. The inner cavity inside the tire and rim is typically large and requires a large volume of foam to fill to flat proof the tire. This adds unnecessary weight and cost.

### SUMMARY

The present disclosure addresses the problems associated with extreme duty agricultural implements, such as heavy duty rotary cutters. In particular, the present design provides a multi-piece wheel rim assembly that permits use of conventional tires on extreme duty agricultural implements while minimizing the inner volume and foam required for filling the tires. Low profile tires are particularly difficult, if not impossible, to mount on a conventional wheel due to the high stiffness required for their sidewalls. The typical way to overcome such difficulty is to include a drop center in the rim base of the conventional wheel to aid in mounting a low profile tire to the wheel. Such a drop center adds to the internal volume, thus again adding undesired weight and cost to foam fill the tire.

In various aspects, the present disclosure provides a multi-piece wheel rim designed to allow use of a low profile side wall tire that has less internal volume and thus requires less foam fill and cost to flat proof the tire. In various non-limiting aspects, the wheel rim is a multi-piece wheel assembly, preferably a two-piece wheel, allowing the mounting of a low profile tire, in particular a low profile extreme duty agricultural implement tire, to the wheel.

One-piece wheels require a well, or the aforementioned drop center (a recess in the center portion of the rim base of the wheel) feature in the rim base to allow the tire bead on one half of the tire to sit in to allow the opposed bead on the other half of the tire clearance over the rim flange during installation. This well adds to the internal volume of the tire. Two-piece wheels are usually symmetrical halves (inner and outer) that are fastened together and do not require any special features for tire mounting. Elimination of the well reduces the internal volume.

In an embodiment, a wheel assembly is provided comprising: an outer section and an inner section, each section having a generally circular face, the face including a wheel hole configured to receive a stub on an axel hub, a first plurality of holes disposed radially outwardly from the wheel hole configured to receive a lug for securing the wheel assembly to an axel hub, a first flange outwardly disposed from a periphery of the face, the first flange forming a wheel rim base, a second plurality of holes radially disposed in the face each to receive a fastener for fastening the outer and inner sections together, and a rim flange formed in a distal peripheral edge of the first flange opposite the face of the section, wherein the first flange of each section is disposed from a periphery of its respective face such that when the outer section and the inner section are fastened together the first flanges are positioned opposite each other and are disposed outwardly from each other, and wherein the outer and inner rim bases of each section are devoid of a well or drop center.

Each section of the wheel assembly can have an inner surface, the inner surface of each section having an outwardly disposed radius forming an annular groove therein at a location at or near the periphery of the face of the section, the annular groove of each section positioned such that when the outer and inner sections are fastened together with the inner surface of the face of the outer section and the inner surface of the face of the inner section in contact with each other the annular grooves are opposite each other and outwardly disposed in opposite directions forming a cavity configured to receive an O-ring.

In an embodiment, a method of forming a wheel assembly is provided, the wheel assembly including a multi-piece wheel and a pneumatic tire mounted on the wheel assembly, comprising the steps of:
a) providing a wheel, the wheel including an outer section and an inner section, each section having a generally circular face, the face including a wheel hole configured to receive a stub on an axel hub, a first plurality of holes disposed radially outwardly from the wheel hole configured to receive a lug for securing the wheel to an axel hub, a first flange outwardly disposed from a periphery of the face, the first flange forming a wheel rim base, a second plurality of holes radially disposed in the face each to receive a fastener for fastening the outer and inner sections together, and a rim flange formed in a distal peripheral edge of the first flange opposite the face of the section, wherein the first flange of each section is disposed from a periphery of its respective face such that when the outer section and the inner section are fastened together the first flanges are positioned opposite each other and are disposed outwardly from each other, and wherein each section has an inner surface, the inner surface of each section having an outwardly disposed radius forming an annular groove therein at a location at or near the periphery of the face of the section, the annular groove of each section positioned such that when the outer and inner sections are fastened together with the inner surface of the face of the outer section and the inner surface of the face of the inner section in contact with each other the annular grooves are opposite each other and outwardly disposed in opposite directions forming a cavity; b) providing a pneumatic tire, the pneumatic tire having opposed first and second sides and a hole centrally disposed in each side; c) placing the outer and inner sections of the wheel on the opposed first and second sides of the tire and pressing the outer section into the center hole of the first side of the tire and pressing the inner section into the center hole of the second side of the tire such that an edge of the first side of the tire comes into contact with the rim base of the outer section and an opposed edge of the second side of the tire comes into contact with the rim base of the inner section and such that ultimately the edge of the first side of the tire is urged into contact with the rim flange of the outer section and the edge of the second side of the tire is urged into contact with the rim flange of the inner section of the tire; d) positioning an O-ring within the cavity to be secured within the cavity; and e) securing the outer and inner sections together. The rim bases of each section can be devoid of a well or drop center.

In any one or more aspects, the method can further include the steps of pressuring the tire after the outer and inner sections have been secured together to stretch the tire, and then filling the tire with foam. The tire can be stretched to its final profile before filling the tire with foam.

In any one or more aspects of either the wheel assembly or the method, or both, each rim base can be generally planar, thereby eliminating a well or drop center in the rim bases. Each rim base can be formed to its respective face at an angle of about 90° to about 95° in relation to the respective face. Each section of the wheel can have an inner surface and the face of the outer section includes a first pattern and the face of the inner section includes a second pattern, and wherein at least a portion of either the first pattern or the second pattern is configured to nest within at least a portion of the other of the first pattern or the second pattern when the outer and inner sections are fastened together with the inner surface of the face of the outer section and the inner surface of the face of the inner section in contact with each other.

Other systems, methods, features, and advantages of the present disclosure for the present wheel will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 depicts a side perspective view of a non-limiting embodiment of the present tire shown from the outside side of the wheel.

FIG. 2A depicts a side elevational view of the outside side of the wheel of FIG. 1.

FIG. 2B is a side elevational view of the wheel of FIG. 1, taken along section line A-A of FIG. 2A.

FIG. 2C is a detail of a section of the wheel of FIG. 2B.

FIG. 2D is a detail of another section of the wheel of FIG. 2B.

FIG. 3 is a side elevational view of the wheel of FIG. 2B showing the wheel in an assembled state.

### DETAILED DESCRIPTION

Described below are various embodiments of the present systems and methods for a wheel. Although particular embodiments are described, those embodiments are mere exemplary implementations of the system and method. One skilled in the art will recognize other embodiments are possible. All such embodiments are intended to fall within the scope of this disclosure. Moreover, all references cited herein are intended to be and are hereby incorporated by reference into this disclosure as if fully set forth herein. While the disclosure will now be described in reference to the above drawings, there is no intent to limit it to the embodiment or embodiments disclosed herein. On the contrary, the intent is to cover all alternatives, modifications and equivalents included within the spirit and scope of the disclosure.

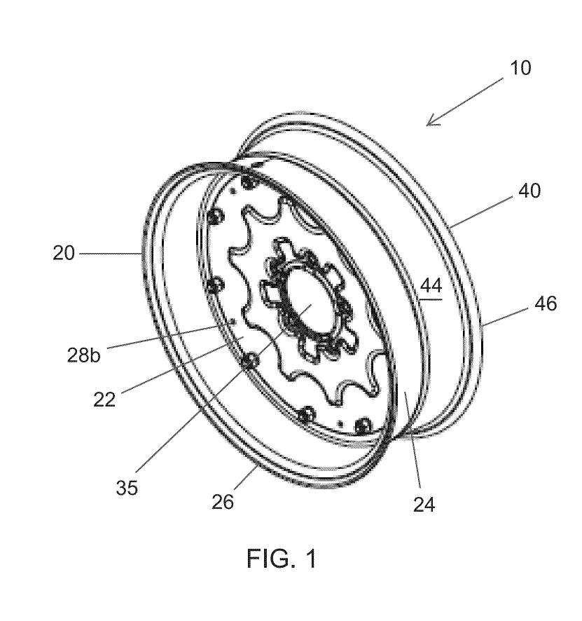

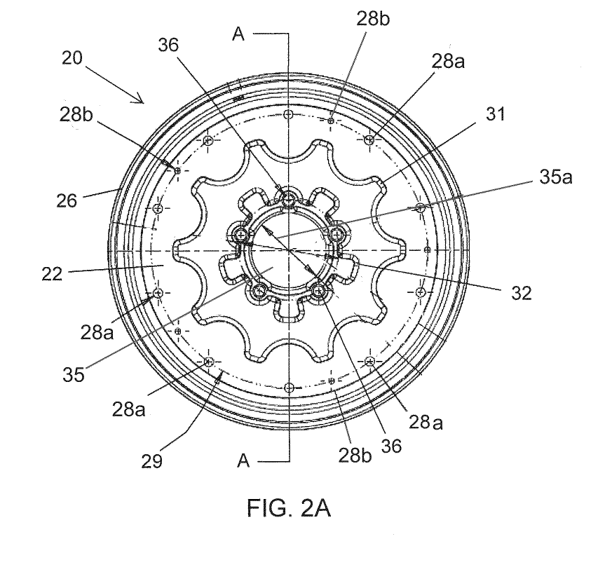

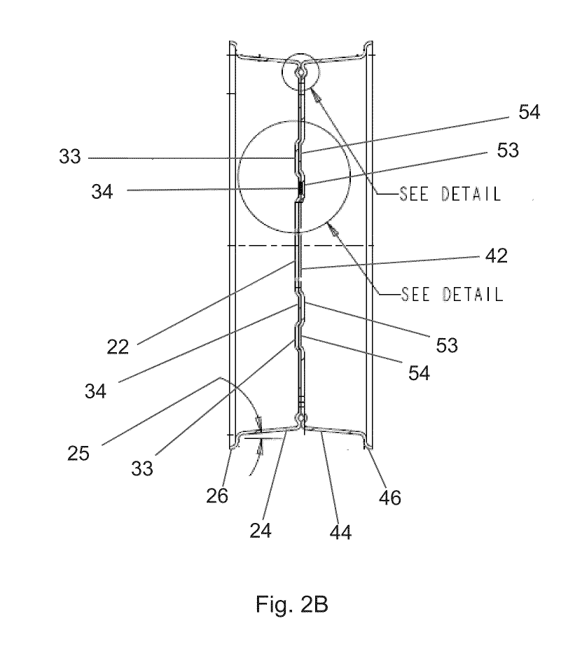

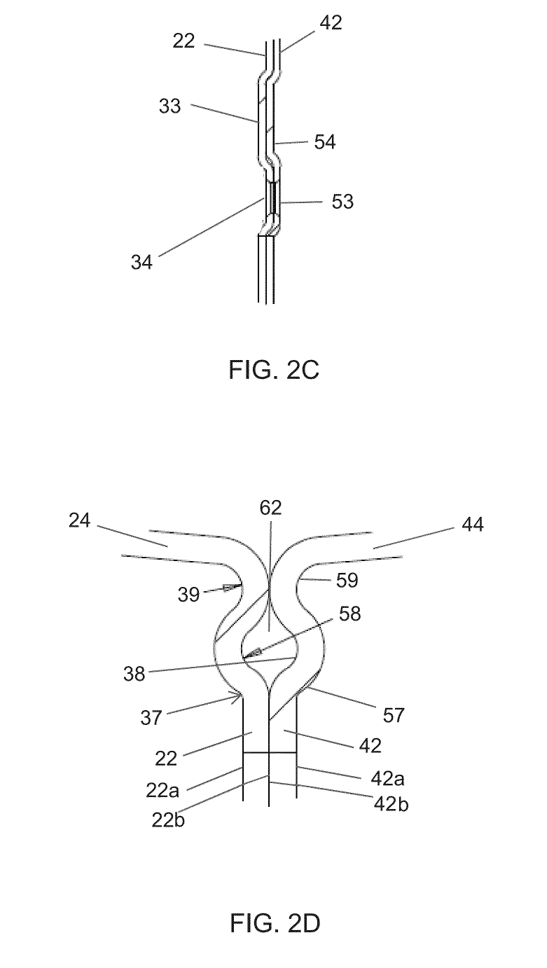

Referring now in more detail to the drawings, in which like numerals indicate like parts throughout the several views, FIG. 1 illustrates an embodiment of the present wheel design. The wheel 10 includes a multi-piece design. As depicted in FIG. 1, the wheel includes at least two pieces, an outer section 20 and an inner section 40. The outer section 20 includes a generally circular recessed outer face 22. A rim base 24 extends outwardly from the periphery the outer face 22 leading to an outer rim flange 26. The wheel 10 similarly includes an inner section 40 that has a generally circular inner face 42 (see, e.g., FIGS. 2B-2D) from which an inner section rim base 44 extends outwardly from the periphery of the inner face 42 leading to inner rim flange 46.

FIG. 2A depicts a front elevational view of the outer section 20 of the wheel. The outer face 22 of the wheel can include an opening or wheel hole 35 having a diameter 35a for receiving the stub on an axel hub. A plurality of radially disposed holes 36 can be provided, each for receiving a lug for mounting the wheel 10 onto an extreme duty agricultural implement, for example a heavy duty rotary cutter. The outer face 22 of the outer section 20 can also include a plurality of holes 28a, b radially disposed 29 about the periphery of the outer face 22 near the angle formed by the outer rim base 24. Holes 28a are configured for receiving fasteners for fastening outer and inner sections 20, 40 together, as described in more detail below. Ten such holes are depicted. Holes 28b are configured for drainage. In some aspects the wheel assembly including a tire can be mounted on a cutter or mower that may have wing sections to which the wheel and tire assembly is mounted. These wing sections can be folded up for transport and storage. In such a folded condition, the wheel assemblies mounted to these sections can rest in a largely horizontal position allowing water and debris to collect in the upward facing wheel half or section. The drainage holes 28b help prevent premature corrosion and damage to the wheel assembly. Five such drainage holes 28b are depicted. One skilled in the art, however, will recognize that the number of such holes 28a, b can be more or less than that depicted. Additionally, the radial location of the holes 28a, b can be varied.

Also depicted are an outer pattern 31 and an inner pattern 32 on outer face 22. The outer pattern 31 can be disposed radially outwardly on the outer face 22 from the inner pattern 32 and from the wheel hole 35. The outer and inner patterns 31, 32 can be optionally included to assist in mating the outer section 20 to the inner section 40 to form the wheel assembly 10, as discussed in more detail below.

The inner face 42 of inner section 40 of the wheel 10 can be constructed similarly to the outer face 22 as depicted in FIG. 2A, with the exception that the surface relief of the optional outer and inner patterns 51, 52 of inner face 42 may be reversed in relation to the surface relief of the outer and inner patterns 31, 32 of outer face 22 as described below. Thus, for example, inner face 42 can also have a plurality of holes radially disposed about the periphery of the inner face 42 near the angle formed by the inner rim base 44 to match the location of the holes 28 in the outer face 22. Inner face 42 can also have an opening or wheel hole, complementing the wheel hole 35 of the outer face, for receiving the stub on an axel hub. A plurality of radially disposed holes can also be provided in inner face 42, each for receiving a lug for mounting the wheel 10 onto the implement. The outer pattern 51 can also be disposed radially outwardly on the inner face 42 from the inner pattern 52 and from the wheel hole.

FIG. 2B is a cross-sectional view taken along section line A-A of FIG. 2A. As can be seen, the rim bases 24, 44 of the outer and inner sections 20, 40, respectively, are devoid of a well or drop center. In various aspects, the portion of each rim base extending inwardly from each respective rim flange 26, 46 to the point where they join their respective outer face 22 and inner face 42 (see FIG. 2D) is generally planar, thereby eliminating the conventional well or drop center required for mounting a low profile tire. In various aspects, each rim base is formed to their respective face at an angle 25 of about 90° to about 100° in relation to their respective face, an angle of 95° providing for example a slightly upward slope from the face 20, 40 extending towards the rim flange 26, 46, as depicted in FIG. 2B.

FIGS. 2B and 2C depict a non-limiting example of how the outer and inner sections 20 and 40 can be mated together to form the wheel 10. As depicted the outer pattern 31 of the outer section 20 can have a raised surface 33 in relation to outer face 22. While the outer pattern 51 of the inner face 42 of inner section 40 can have a surface 54 that is recessed in relation to inner face 42, complementing the raised surface 33 of the outer pattern 31 of the outer face 22. Thus, when the outer and inner sections 20 and 40 are properly positioned against each other the recessed surface 54 of the inner face 42 can nest within the raised surface 33 of the outer face 22. An inner pattern 32 for the outer face 22 of outer section 20 may similarly be configured to mate with an inner pattern 52 of the inner face 42 of inner section 40. As depicted, the inner pattern 32 of the outer face 22 can have a recessed surface 34 in relation to outer face 22 while the inner pattern 52 of the inner face 42 can have a raised surface 53 in relation to inner face 42 to complement and receive the recessed surface 34 of the outer face 22. Thus, the inner patterns 32, 52 of the outer and inner faces 22, 42 are reversed in relation to the outer patterns 31, 51. The inner and outer patterns may be formed in the faces of the inner and outer sections by, for example, stamping the patterns into the faces. One skilled in the art will recognize, however, that both an outer pattern and an inner pattern need not be provided in the outer and inner faces. One may be provided without the other. Further many different patterns or configurations can be provided for nesting and mating the inner and outer faces 22, 42 together.

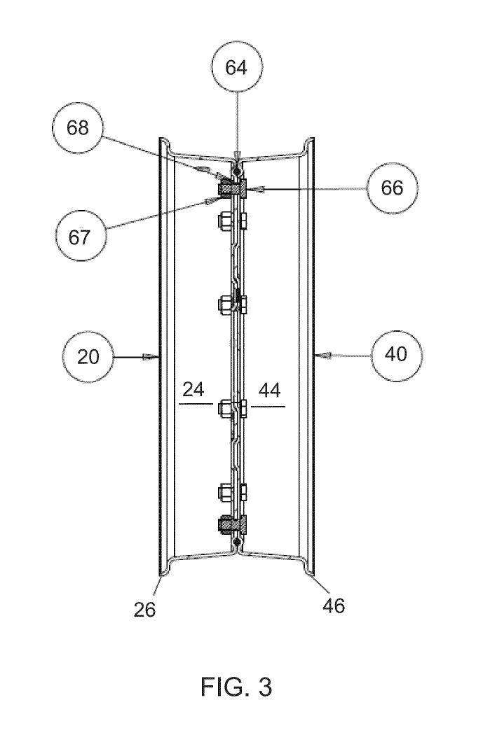

FIG. 2D depicts enlarged sectional view or detail of FIG. 2B. Illustrated in FIG. 2D are outer peripheral cross-sections of the outer section 20 and the inner section 40, having an outer face 22 and inner face 42, respectively. Outer face 22 has an outer surface 22a and an inner surface 22b. Similarly inner face 42 has an outer surface 42a and an inner surface 42b. Each face includes 3 radiuses forming a cavity 62. Outer section 20 includes a first, inner radius 37, a second, outwardly disposed, radius 38 forming an annular groove in the inner surface 22b of the outer face 22, and a third radius 39 leading to the flange 24 forming the outer rim base 24. Similarly, inner face 42 includes three opposed complimentary radiuses, a first, inner radius 57, a second, outwardly disposed, radius 58 forming an annular groove in the inner surface 42b of the inner face 42, and a third radius 59 which then leads to the flange forming the inner rim base 44. The purpose for the complementary radiuses, in particular the opposed, outwardly disposed second radiuses 38, 58, is to form cavity 62. Cavity 62 can be configured to receive an O-ring 64 (see FIG. 3).

As depicted in FIG. 3, the outer section 20 and the inner section 40 of the wheel can be assembled by, for example, using a series of screws, nuts and washers 66, 67 and 68 to secure the one section to the other section. This also permits securing an O-ring 64 within cavity 62. The O-ring, can be used to seal, even if temporarily, the inner volume of the wheel and tire for the purpose of foam filling the inside of the tire.

As an example, to mount and foam fill a low profile extreme duty agricultural implement tire to the wheel 10, the outer and inner sections 20, 40 of the wheel can be placed on opposed sides of the tire and each pressed into the center hole of the tire such that outer and inner beads of the tire come into contact with the outer rim base 24 and inner rim base 44. As the outer and inner sections 20, 40 are pressed into the center hole of the tire the outer and inner beads of the tire are urged into contact with the outer rim flange 26 and inner rim flange 46, respectively. In the meantime an O-ring 64 can be positioned within the annular cavity 62 to be secured therein. The outer and inner sections 20, 40 can then be secured together by, for example, the screws, nuts and washers, 66, 67 and 68. Then to foam fill the tire, the tire can be pressurized for period of time, for example, 24 hours to allow the tire to stretch and set to its final profile. The tire then can be foam filled to flat-proof the tire, for example by introducing the foam fill through the stem hole of the tire. The O-ring can help retain the foam fill within the inner cavity of the tire and also allow the foam to be filled to a predetermined pressure until it cures.

Ratios, amounts, and other numerical values or data may be expressed in a range format. It is to be understood that such a range format is used for convenience and brevity, and should be interpreted in a flexible manner to include not only the numerical values explicitly recited as the limits of the range, but also to include all the individual numerical values or sub-ranges encompassed within that range as if each numerical value and sub-range is explicitly recited. To illustrate, a range of “about 0.1% to about 5%” should be interpreted to include not only the explicitly recited numerical values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. The upper and lower limits of these smaller ranges may independently be included in the smaller ranges and are also encompassed within the disclosure, subject to any specifically excluded limit in the stated range. Where the stated range includes one or both of upper or lower limits, ranges excluding either or both of those included limits are also included in the disclosure .In an embodiment, the term “about” can include traditional rounding according to significant figure of the numerical value. In addition, the phrase “about ‘x’ to ‘y’” includes “about ‘x’ to about ‘y’”.

As will be apparent to those of skill in the art upon reading this disclosure, each of the individual embodiments described and illustrated has discrete components and features which may be readily separated from or combined with the features of any of the other several embodiments without departing from the scope or spirit of the present disclosure. Any recited method can be carried out in the order of events recited or in any other order logically possible.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

1. A wheel assembly comprising:
an outer section and an inner section;
each section having a generally circular face, the face including a wheel hole configured to receive a stub on an axel hub, a first plurality of holes disposed radially outwardly from the wheel hole configured to receive a lug for securing the wheel assembly to an axel hub, a first flange outwardly disposed from a periphery of the face, the first flange forming a wheel rim base, a second plurality of holes radially disposed in the face each to receive a fastener for fastening the outer and inner sections together, and a rim flange formed in a distal peripheral edge of the first flange opposite the face of the section;
wherein the first flange of each section is disposed from a periphery of its respective face such that when the outer section and the inner section are fastened together the first flanges are positioned opposite each other and are disposed outwardly from each other, and wherein the outer and inner rim bases of each section are devoid of a well or drop center.

2. The wheel assembly of claim 1, wherein each rim base is generally planar, thereby eliminating a well or drop center in the rim bases.

3. The wheel assembly of claim 1, wherein each rim base is formed to its respective face at an angle of about 90° to about 100° in relation to the respective face.

4. The wheel assembly of claim 1, wherein each section has an inner surface, the inner surface of each section having an outwardly disposed radius forming an annular groove therein at a location at or near the periphery of the face of the section, the annular groove of each section positioned such that when the outer and inner sections are fastened together with the inner surface of the face of the outer section and the inner surface of the face of the inner section in contact with each other the annular grooves are opposite each other and outwardly disposed in opposite directions forming a cavity configured to receive an O-ring.

5. The wheel assembly of claim 1, wherein each section has an inner surface and the face of the outer section includes a first pattern and the face of the inner section includes a second pattern, and wherein at least a portion of either the first pattern or the second pattern is configured to nest within at least a portion of the other of the first pattern or the second pattern when the outer and inner sections are fastened together with the inner surface of the face of the outer section and the inner surface of the face of the inner section in contact with each other.

6. A method of forming a wheel assembly, the wheel assembly including a multi-piece wheel and a pneumatic tire mounted on the wheel assembly, comprising the steps of:
a) providing a wheel, the wheel including an outer section and an inner section, each section having a generally circular face, the face including a wheel hole configured to receive a stub on an axel hub, a first plurality of holes disposed radially outwardly from the wheel hole configured to receive a lug for securing the wheel to an axel hub, a first flange outwardly disposed from a periphery of the face, the first flange forming a wheel rim base, a second plurality of holes radially disposed in the face each to receive a fastener for fastening the outer and inner sections together, and a rim flange formed in a distal peripheral edge of the first flange opposite the face of the section, wherein the first flange of each section is disposed from a periphery of its respective face such that when the outer section and the inner section are fastened together the first flanges are positioned opposite each other and are disposed outwardly from each other, and wherein each section has an inner surface, the inner surface of each section having an outwardly disposed radius forming an annular groove therein at a location at or near the periphery of the face of the section, the annular groove of each section positioned such that when the outer and inner sections are fastened together with the inner surface of the face of the outer section and the inner surface of the face of the inner section in contact with each other the annular grooves are opposite each other and outwardly disposed in opposite directions forming a cavity;
b) providing a pneumatic tire, the pneumatic tire having opposed first and second sides and a hole centrally disposed in each side;
c) placing the outer and inner sections of the wheel on the opposed first and second sides of the tire and pressing the outer section into the center hole of the first side of the tire and pressing the inner section into the center hole of the second side of the tire such that an edge of the first side of the tire comes into contact with the rim base of the outer section and an opposed edge of the second side of the tire comes into contact with the rim base of the inner section and such that ultimately the edge of the first side of the tire is urged into contact with the rim flange of the outer section and the edge of the second side of the tire is urged into contact with the rim flange of the inner section of the tire;
d) positioning an O-ring within the cavity to be secured within the cavity; and
e) securing the outer and inner sections together.

7. The method of claim 6, wherein the rim bases of each section are devoid of a well or drop center.

8. The method of claim 7, wherein each rim base is generally planar, thereby eliminating a well or drop center in the rim bases.

9. The method of claim 8, wherein each rim base is formed to its respective face at an angle of about 90° to about 100° in relation to the respective face,

10. The method of claim 6, further including the steps of pressuring the tire after the outer and inner sections have been secured together to stretch the tire, and then filling the tire with foam.

11. The method of claim 10, wherein the tire is stretched to its final profile before filling the tire with foam.

12. The method of claim 6, wherein each section has an inner surface and the face of the outer section includes a first pattern and the face of the inner section includes a second pattern, and wherein at least a portion of either the first pattern or the second pattern is configured to nest within at least a portion of the other of the first pattern or the second pattern when the outer and inner sections are fastened together with the inner surface of the face of the outer section and the inner surface of the face of the inner section in contact with each other.

13. The wheel assembly of claim 2, wherein each rim base is formed to its respective face at an angle of about 90° to about 100° in relation to the respective face.

14. The wheel assembly of claim 2, wherein each section has an inner surface, the inner surface of each section having an outwardly disposed radius forming an annular groove therein at a location at or near the periphery of the face of the section, the annular groove of each section positioned such that when the outer and inner sections are fastened together with the inner surface of the face of the outer section and the inner surface of the face of the inner section in contact with each other the annular grooves are opposite each other and outwardly disposed in opposite directions forming a cavity configured to receive an O-ring.

15. The wheel assembly of claim 2, wherein each section has an inner surface and the face of the outer section includes a first pattern and the face of the inner section includes a second pattern, and wherein at least a portion of either the first pattern or the second pattern is configured to nest within at least a portion of the other of the first pattern or the second pattern when the outer and inner sections are fastened together with the inner surface of the face of the outer section and the inner surface of the face of the inner section in contact with each other.

16. The wheel assembly of claim 4, wherein each section has an inner surface and the face of the outer section includes a first pattern and the face of the inner section includes a second pattern, and wherein at least a portion of either the first pattern or the second pattern is configured to nest within at least a portion of the other of the first pattern or the second pattern when the outer and inner sections are fastened together with the inner surface of the face of the outer section and the inner surface of the face of the inner section in contact with each other.

17. The method of claim 6, wherein each rim base is generally planar, thereby eliminating a well or drop center in the rim bases.

18. The method of claim 8, further including the steps of pressuring the tire after the outer and inner sections have been secured together to stretch the tire, and then filling the tire with foam.

19. The method of claim 18, wherein the tire is stretched to its final profile before filling the tire with foam.

20. The method of claim 10, wherein each section has an inner surface and the face of the outer section includes a first pattern and the face of the inner section includes a second pattern, and wherein at least a portion of either the first pattern or the second pattern is configured to nest within at least a portion of the other of the first pattern or the second pattern when the outer and inner sections are fastened together with the inner surface of the face of the outer section and the inner surface of the face of the inner section in contact with each other.
